(19) United States
(12) Patent Application Publication
(10) Pub. No.: US 2024/0283202 A1
(43) Pub. Date: Aug. 22, 2024

(54) BOARD COAXIAL CONNECTOR WITH AN IMPROVED CONTACT

(71) Applicants: FUDING PRECISION COMPONENTS (SHENZHEN) CO., LTD., Shenzhen (CN); FOXCONN INTERCONNECT TECHNOLOGY LIMITED, Grand Cayman (KY)

(72) Inventors: TENG HUANG, Shenzhen (CN); SHIH-WEI HSIAO, New Taipei (TW); YU-SAN HSIAO, New Taipei (TW); DE-JIN CHEN, Shenzhen (CN); HE CHEN, Zhengzhou (CN)

(21) Appl. No.: 18/430,473

(22) Filed: Feb. 1, 2024

(30) Foreign Application Priority Data
Feb. 16, 2023 (CN) 202310158583.X

(51) Int. Cl. H01R 24/50; H01R 103/00

(52) U.S. Cl. CPC H01R 24/50; H01R 2103/00

(57) ABSTRACT

A board coaxial connector includes: a first insulator, a first inner conductor retained in the first insulator and having a mating portion and a first connecting portion extending out of the first insulator, a first outer conductor having a third connecting portion and retaining the first insulator, a second outer conductor mounted on the circuit board and having a fourth connecting portion, and a second inner conductor having a second connecting portion and a tail portion mounting on the circuit board, wherein the first connecting portion is connected with the second connecting portion, the third connecting portion is connected with the fourth connecting portion, and the first connecting portion of the first inner conductor is movable to slightly deviate from an axis of the second inner conductor.

### BACKGROUND OF THE INVENTION

### Field of the Invention

The present invention relates to a coaxial connector mounted on a board.

### Description of Related Arts

China Application No. 114552291 discloses a floating radio connector, for connecting signals from a car camera, which comprises a fixing shell fixed on a circuit board, a floating shell electrically connected with the fixing shell, a contact fixed on the circuit board with a long fixing tail. The contact is movable through deformation of the long fixing tail but it is prone to damage under repeated use.

Therefore, it is desired to provide a board coaxial connector with an improved contact.

### SUMMARY OF THE INVENTION

An object of the present invention is to provide a board coaxial connector with an improved contact. To achieve the above object, a board coaxial connector comprises: a first insulator, a first inner conductor retained in the first insulator and comprising a mating portion and a first connecting portion extending out of the first insulator, a first outer conductor having a third connecting portion and retaining the first insulator, a second outer conductor mounted on the circuit board and having a fourth connecting portion, and a second inner conductor having a second connecting portion and a tail portion mounting on the circuit board, wherein the first connecting portion is connected with the second connecting portion, the third connecting portion is connected with the fourth connecting portion, and the first connecting portion of the first inner conductor is movable to slightly deviate from an axis of the second inner conductor.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of a coaxial connector assembly including a device coaxial connector retained in a device casing and a board coaxial connector separated from each other;

FIG. 2 is a perspective view of the coaxial connector assembly mated with each other in FIG. 1;

FIG. 3 is an exploded perspective view of the board connector in FIG. 1;

FIG. 4 is an exploded perspective view of the device connector from the device casing in FIG. 1;

FIG. 5 is a cross-sectional view of the device connector retained in the device casing taken along line A-A of FIG. 1;

FIG. 6 is a cross-sectional view of the board connector taken along line B-B of FIG. 1; and

FIG. 7 is a cross-sectional view of the coaxial connector assembly along line C-C of FIG. 2.

### DETAILED DESCRIPTION OF THE PREFERRED EMBODIMENT

Reference will now be made in detail to the preferred embodiments of the present invention.

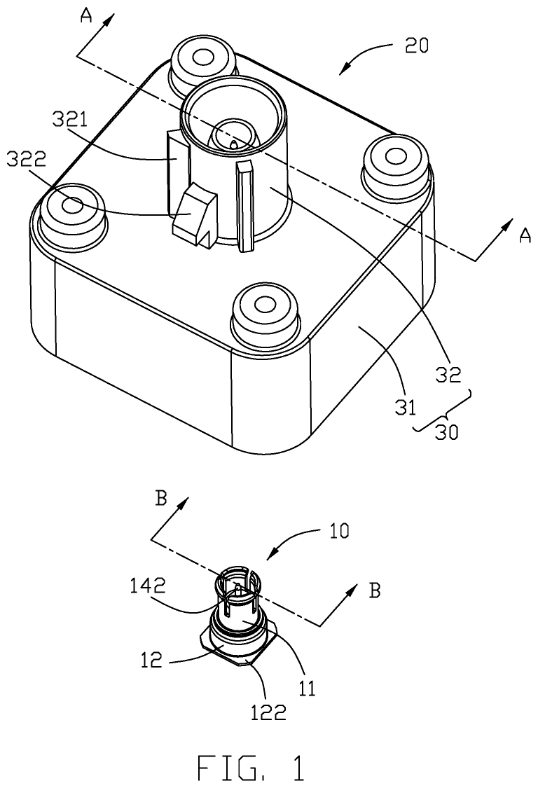

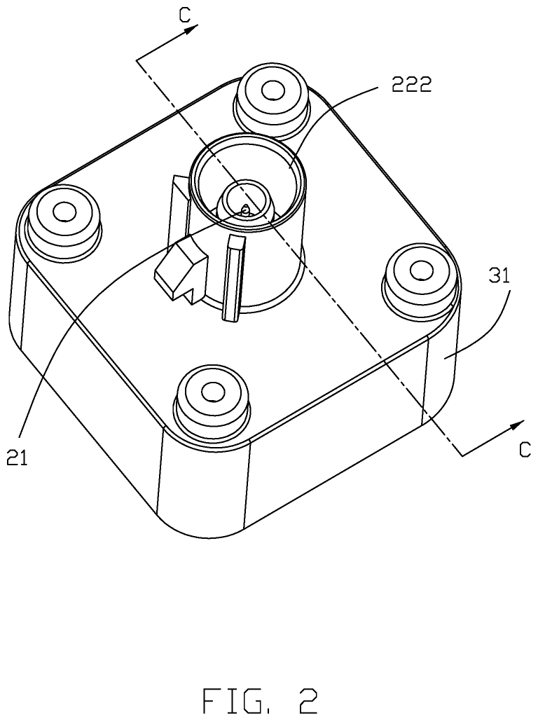

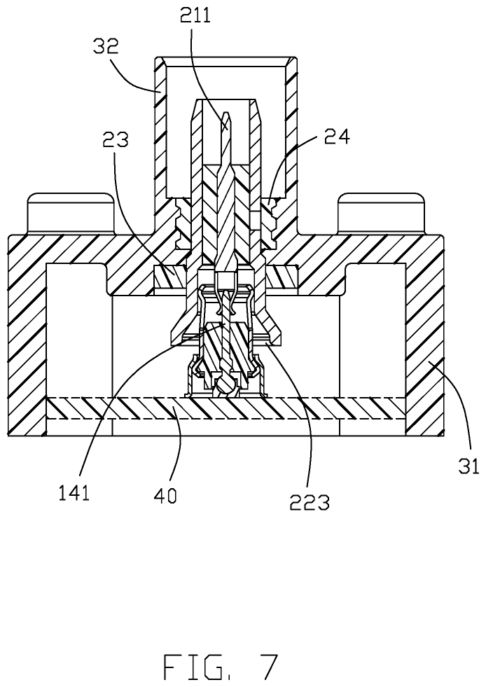

Referring to FIGS. 1-2, 5, and 7, a coaxial connector assembly is used in a vehicle for transmitting signals from cameras, which includes a device coaxial connector 20 for mating with a cable end from camera and a board coaxial connector 10 for being mounted on a circuit board 40. The device coaxial connector 20 is assembled and retained in a device casing 30, the device casing 30 is mounted in the vehicle and the board coaxial connector 10 with the circuit board 40 is also received in the device casing 30 to mate with the device coaxial connector 20. The board coaxial connector 10 is of a floating connector, which can slightly float relative to the device coaxial connector 20.

Referring to FIGS. 1, 3, and 6, the board coaxial connector 10 includes a first outer conductor 11, a second outer conductor 12, a first insulator 13, a first inner conductor 14, and a second inner conductor 15. The first inner conductor 14 is fixed in the first insulator 13 with a mating portion 141 extending upwardly out of the first insulator 13 and a first connecting portion 142 extending downwardly. The second inner conductor 15 has a tail portion 151 and a second connecting portion 152. The first connecting portion 142 has a spherical end 1421, the second connecting portion 152 has a base portion 1521 and a plurality of fence portions 1522 extending upwardly from the base portion 1521 to form a concavity for interacting with the spherical end 1421. Alternatively, the first connecting portion 142 may have the concavity while the second connecting portion 152 is provided with the spherical end. Therefore, the first connecting portion 142 can deviate within certain angles relative to an upper-lower direction, so as to adapt to a vehicle vibration.

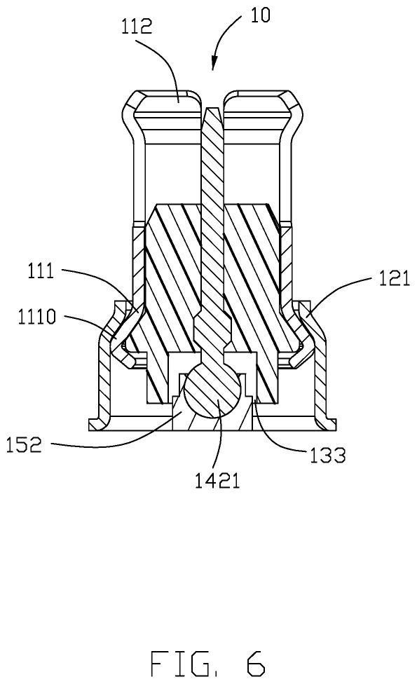

Referring to FIGS. 1, 3, and 6, the first outer conductor 11 is designed as a hollow tube with plural slots 112 opening through an upper end thereof, and a third connecting portion 111 at the lower end of the hollow tube. The second outer conductor 12 has a fourth connecting portion 121 at the upper end thereof for mating with the third connecting portion 111 and a mounting portion 122 for fixing on the circuit board 40. The third connecting portion 111 is received in the fourth connecting portion 121. As best shown in FIG. 6, the third connecting portion 111 bulges in radial directions and form a protruding portion 1110 with a V-shaped cross section, and the fourth connecting portion 121 shrinks inwardly near the upper end thereof, so as to prevent the third connecting portion 111 from separating from an upper opening of the fourth connecting portion 121.

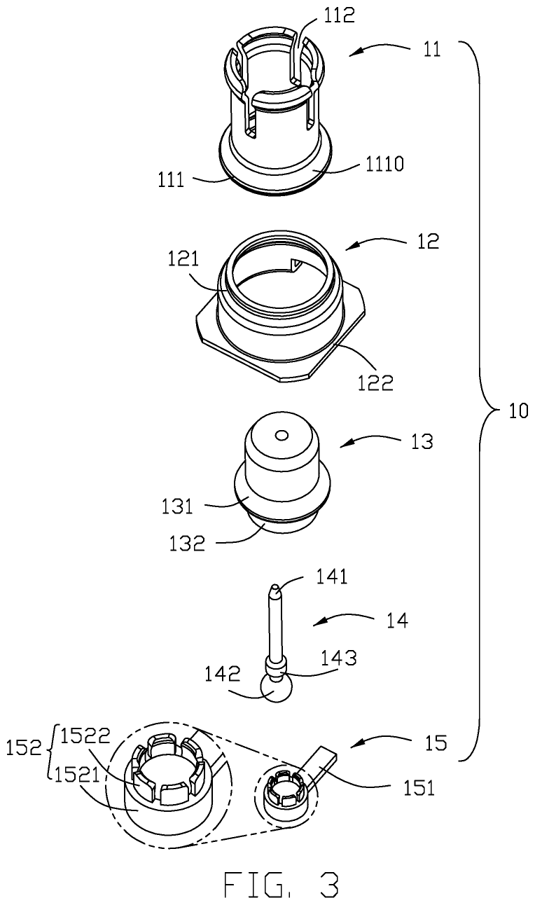

Referring to FIGS. 3 and 6, the first insulator 13 has a ring rib 131 protruding radially from an outer face near the lower end thereof and a receiving groove 133 formed by a circumferential wall 132 and opening downwards. The first insulator 13 is assembled into the first outer conductor 11 from a lower end thereof and the ring rib 131 is received in the protruding portion 1110. The second connecting portion 152 and the spherical end 1421 of the first connecting portion 142 received in the concavity of the second connecting portion 152 are at least partially received in the receiving groove 133. As the spherical end 1421 of the first connecting portion 142 can rotate in the concavity of the second connecting portion 152 and the third connecting portion 111 can swing relative to the fourth connecting portion 121, the first insulator 13 and the first outer conductor 11 which are fixed together with the first inner conductor 14 can deviate relative to the second outer conductor 12 or the second inner conductor 15 when the first inner conductor 141 floats due to the car vibration, minimizing the influence of the car vibration on the board connector 10.

Firstly, the first insulator 13 and the first inner conductor 14 which are injection molded together, are inserted into the first outer conductor 11. Secondly, the second connecting portion 152 is assembled into the first insulating housing, wherein the spherical end 1421 of the first connecting portion 142 is received in the receiving groove 133 to make the first connecting portion 142 mated with the second connecting portion 152. Thirdly, the second outer conductor 12 is sleeved at an outside the first outer conductor 11 from the upper end of the first outer conductor to the lower end of the first outer conductor 11. The mounting portion 122 of the second outer conductor 12 and the tail portion 151 of the second inner conductor 15 is soldered on the circuit board 40. Alternatively, the board connector 10 may further includes a second insulator for fixing the second inner conductor 15 to the second outer conductor 12. The second inner conductor 15 can be retained in the second insulator firstly to make the second inner conductor 15 and the second insulator as a whole.

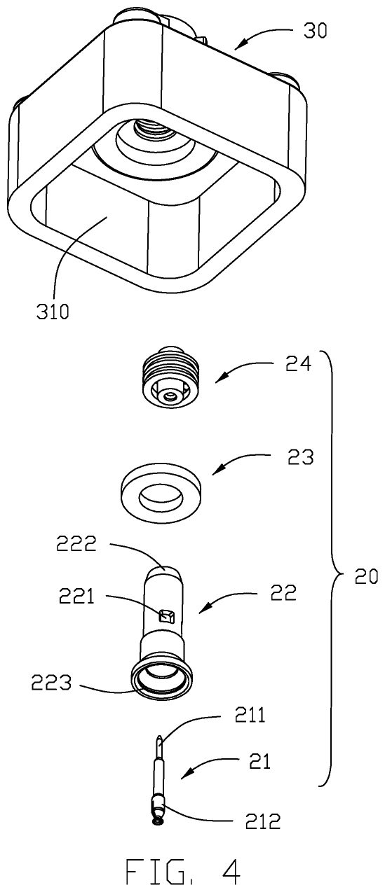

Referring to FIGS. 1-2 and 4-5, the device connector 20 includes a third contact 21, a third insulator 23, a fourth insulator 24 and a third shell 22. The device connector 20 is fixed and sealed in the device casing 30 by the third insulator 23 and the fourth insulator 24. The third insulator 23 is of a sealing ring. The third shell 22 includes an upper mating tube 222 extending upwardly out from the fourth insulator 24, and a lower mating tube 223 extending downwardly out from the fourth insulator 24. The third contact 21 defines an upper mating portion 211 extending upwardly out from the fourth insulator 24 and is exposed in the upper mating tube 222 and a lower mating portion 212 extending downwardly out from the fourth insulator 24 and is exposed in the lower mating tube 223. The device casing 30 has a main portion 31 which forms a receiving cavity 310 and an outer mating tube 32 extending upwardly from the main portion 31, the upper mating portion 211 and the upper mating tube 222 are both received in the outer mating tube 32, the lower mating portion 212 and the lower mating tube 223 are both received in the receiving cavity 310. The inner face of the outer mating tube 32 near the main portion 31 and the outer face of the third shell 22 are spaced and form a fixing groove, some molding gel is poured in the fixing groove and flows in the third shell 22 through a notch 221 of the third shell 22, the fourth insulator 24 includes an inner column 241 formed by the molding gel in the upper connecting tube 222 and an outer ring 242 formed by the molding gel in the fixing groove. The third contact 21 is fixed in the third shell 22 by the inner column 241 and the third shell 22 is fixed in the device casing by the outer ring 242, therefore, the third contact 21, the third shell 22 and the device casing 30 are united together by the fourth insulator 24. In order to make the fourth insulator 24 fixed more firmly in the device casing 30, the inner face of the outer connecting tube 32 is serrated. There are some guiding ribs 321 extending along an upper and lower direction and a latching hook 322. The lower contacting portion 212 is defined as a female end with a mating hole, the mating hole has a neck 2121 shrinks circumferentially inward.

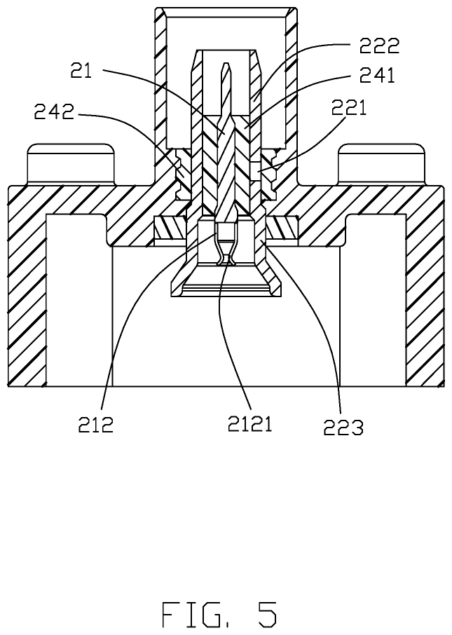

Referring to FIGS. 5-7, the board connector 10 is engaged with the device connector 20 from the lower mating tube 223. The needle-shaped mating portion 141 contacts with the neck portion 2121 of the third inner conductor 21 when the board connector 10 gets contact with the device connector 20. The first inner conductor 14, the first insulator 13 and the first outer conductor 11 offset from the central axis of the second outer conductor 12 or the second inner conductor 15 during the process of inserting the board connector 10 into the lower mating tube 223. The angle that the first inner conductor 14 can deviate relative to the axis of the second outer conductor 12 or the second inner conductor 15 is within 5 degrees. The concavity of the second inner conductor 15 is spaced from the receiving groove 133 of the first insulator 13 by an offset gap, thus, the first insulator 13 can swing relative to the concavity when the spherical end 1421 of the first inner conductor 14 rotates in the concavity, enabling the board connector 10 an offset of 0.3 mm in the radial direction.

Although the present invention has been described with reference to particular embodiments, it is not to be construed as being limited thereto. Various alterations and modifications can be made to the embodiments without in any way departing from the scope or spirit of the present invention as defined in the appended claims.

1. A board coaxial connector adapted for mounting on a circuit board, comprising:
a first insulator;
a first inner conductor retained in the first insulator and comprising a mating portion and a first connecting portion extending out of the first insulator;
a first outer conductor having a third connecting portion and retaining the first insulator;
a second outer conductor mounted on the circuit board and having a fourth connecting portion; and
a second inner conductor having a second connecting portion and a tail portion mounting on the circuit board;
wherein the first connecting portion is connected with the second connecting portion, the third connecting portion is connected with the fourth connecting portion, and the first connecting portion of the first inner conductor is movable to slightly deviate from an axis of the second inner conductor.

2. The board coaxial connector as claimed in claim 1, wherein one of the first connecting portion and the second connecting portion has a spherical end, the other of the first connecting portion and the second connecting portion has a concavity, and the spherical end is received in the concavity.

3. The board coaxial connector as claimed in claim 2, the spherical end is able to rotate in the concavity to offset an axis of the first inner conductor from an axis of the second inner conductor.

4. The board coaxial connector as claimed in claim 2, wherein the second connecting portion has a base portion and a plurality of fence portions extending upwardly from the base portion, and the concavity is formed by the fence portions.

5. The board coaxial connector as claimed in claim 2, wherein the first outer conductor has a ring of protruding portion bulging radially at a lower end thereof, an upper end of the second outer conductor inclines inwardly for preventing the protruding portion of the first outer conductor from separating from the fourth connecting portion of the second outer conductor.

6. The board coaxial connector as claimed in claim 5, wherein the protruding portion has a V-shaped cross section which inclines outwardly firstly and then inclines inwardly.

7. The board coaxial connector as claimed in claim 5, wherein the first insulator has a ring rib protruding radially from an outer face thereof and a receiving groove opening downwards, the ring rib is received in the protruding portion, and the fence portions and the spherical end are received in the receiving groove.

8. The board coaxial connector as claimed in claim 7, wherein the concavity of the second inner conductor is spaced from the receiving groove of the first insulator by an offset gap, and the first insulator is capable of swinging relative to the concavity when the spherical end of the first inner conductor rotates in the concavity.

9. The board coaxial connector as claimed in claim 1, wherein the first inner conductor is able to deviate relative to the axis of the second inner conductor with angles within 5 degrees.

10. The board coaxial connector as claimed in claim 1, wherein the mating portion of the first inner conductor is of a needle shape.

11. A board coaxial connector adapted for mounting on a circuit board, comprising:
an insulator;
a first inner conductor retained in the insulator and comprising a mating portion and a first connecting portion;
a second inner conductor comprising a second connecting portion and a tail portion mounted on the circuit board;
a first outer conductor comprising a mating tube and a third connecting portion, the insulator being retained in the first outer conductor and the mating portion of the first inner conductor being received in the mating tube; and
a second outer conductor comprising a fourth connecting portion and a mounting portion retained on the circuit board;
wherein the third connecting portion is retainably engaged with the fourth connecting portion, and the first connecting portion is swiveled to the second connecting portion.

12. The board coaxial connector as claimed in claim 11, wherein the third connecting portion has a spherical end, and the fourth connecting portion has a concavity receiving the spherical end.

13. The board coaxial connector as claimed in claim 11, wherein the third connecting portion bulges radially and forms a protruding portion at a lower end of the first outer conductor, and the fourth connecting portion converges at an upper end of the second outer conduct for preventing the protruding portion of the third connecting portion from disengaging the fourth connecting portion.

14. The board connector as claimed in claim 13, wherein the second outer conductor is spaced a ring of gap from the second inner conductor, and the first insulator defines a ring of rib retained in the protruding portion and a circumferential wall extending downwardly from the rib into the ring of gap.

15. The board connector as claimed in claim 13, wherein the protruding portion has a V-shaped cross section which inclines outwardly firstly and then inclines inwardly.

16. A coaxial connector assembly comprising:
a circuit board;
a lower assembly comprising an outer conductor and an inner conductor retained on the circuit board; and
an upper assembly comprising an outer conductor, an insulator retained in the outer conductor, and an inner conductor retained in the insulator;
wherein the upper assembly is assembled to the lower assembly, one of the inner conductors has a spherical end, the other of the inner conductors has a concavity, and the spherical end is received in the concavity.
